(19) United States
(12) Patent Application Publication
(10) Pub. No.: US 2026/0304540 A1
(43) Pub. Date: Oct. 1, 2026

(54) APPARATUS AND METHOD OF HEADER COMPRESSION FOR MULTICAST RECEPTION IN RRC INACTIVE STATE IN WIRELESS COMMUNICATION SYSTEM

(71) Applicant: Samsung Electronics Co., Ltd., Suwon-si, Gyeonggi-do (KR)

(72) Inventors: Anil AGIWAL, Suwon-si (KR); Sangkyu BAEK, Suwon-si (KR)

(21) Appl. No.: 18/880,391

(22) PCT Filed: Jul. 21, 2023
(86) PCT No.: PCT/KR2023/010535

§ 371 Date: Dec. 31, 2024

(30) Foreign Application Priority Data
Aug. 9, 2022 (KR) 10-2022-0099267

(51) Int. Cl. H04W 76/27; H04B 17/318; H04W 76/40

(52) U.S. Cl. CPC H04W 76/27; H04B 17/328; H04W 76/40

(57) ABSTRACT

The disclosure relates to a 5G or 6G communication system (or a mobile communication system) for supporting a higher data transmission rate. Specifically, the disclosure relates to an apparatus, a method and a system for header compression for multicast reception in a radio resource control (RRC) inactive state in wireless communication system (or mobile communication system).

### TECHNICAL FIELD

The disclosure relates to a wireless communication system (or a mobile communication system). Specifically, the disclosure relates to an apparatus, a method and a system for header compression for multicast reception in a radio resource control (RRC) inactive state in wireless communication system (or mobile communication system).

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/ protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Recently, there are needs to enhance multicast reception procedure.

### DISCLOSURE OF INVENTION

### Solution to Problem

Aspects of the disclosure are to address at least the above-mentioned problems and/or disadvantages and to provide at least the advantages described below. Accordingly, an aspect of the disclosure is to provide a communication method and system for converging a fifth generation (5G) communication system for supporting higher data rates beyond a fourth generation (4G).

In accordance with an aspect of the disclosure, a method performed by a terminal is provided. The method comprises: receiving, from a base station, a radio resource control (RRC) release message including a suspend configuration, the RRC release message including a configuration of a multicast reception in an RRC inactive state; identifying an initiation of the multicast reception in the RRC inactive state based on the configuration; performing a packet data convergence protocol (PDCP) re-establishment of a multicast radio bearer (MRB) for the multicast reception in the RRC inactive state; and receiving, while the terminal is in the RRC inactive state, the multicast reception.

In accordance with another aspect of the disclosure, a terminal is provided. The terminal comprises: a transceiver; and a controller coupled with the transceiver and configured to: receive, from a base station, a radio resource control (RRC) release message including a suspend configuration, the RRC release message including a configuration of a multicast reception in an RRC inactive state, identify an initiation of the multicast reception in the RRC inactive state based on the configuration, perform a packet data convergence protocol (PDCP) re-establishment of a multicast radio bearer (MRB) for the multicast reception in the RRC inactive state, and receive, while the terminal is in the RRC inactive state, the multicast reception.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates an example of a header compression handling procedure in accordance with an embodiment of the disclosure.

FIG. 2 illustrates another example of a header compression handling procedure in accordance with an embodiment of the disclosure.

FIG. 3 illustrates another example of a header compression handling procedure in accordance with an embodiment of the disclosure.

FIG. 4 illustrates another example of a header compression handling procedure in accordance with an embodiment of the disclosure.

FIG. 5 illustrates another example of a header compression handling procedure in accordance with an embodiment of the disclosure.

FIG. 6 illustrates another example of a header compression handling procedure in accordance with an embodiment of the disclosure.

FIG. 7 is a block diagram of a terminal according to an embodiment of the disclosure.

FIG. 8 is a block diagram of a base station according to an embodiment of the disclosure.

Throughout the drawings, like reference numerals will be understood to refer to like parts, components, and structures.

### BEST MODE FOR CARRYING OUT THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart.

Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out operations of functions described in the flowchart.

A block of a flowchart may correspond to a module, a segment, or a code containing one or more executable instructions implementing one or more logical functions, or may correspond to a part thereof. In some cases, functions described by blocks may be executed in an order different from the listed order. For example, two blocks listed in sequence may be executed at the same time or executed in reverse order.

In this description, the words “unit”, “module” or the like may refer to a software component or hardware component, such as, for example, a field-programmable gate array (FPGA) or an application-specific integrated circuit (ASIC) capable of carrying out a function or an operation. However, a “unit”, or the like, is not limited to hardware or software. A unit, or the like, may be configured so as to reside in an addressable storage medium or to drive one or more processors. Units, or the like, may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose larger components and units. Components and units may be configured to drive a device or one or more processors in a secure multimedia card.

Prior to the detailed description, terms or definitions necessary to understand the disclosure are described. However, these terms should be construed in a non-limiting way.

The “base station (BS)” is an entity communicating with a user equipment (UE) and may be referred to as BS, base transceiver station (BTS), node B (NB), evolved NB (eNB), access point (AP), 5G NB (5GNB), or gNB.

The “UE” is an entity communicating with a BS and may be referred to as UE, device, mobile station (MS), mobile equipment (ME), or terminal.

In the recent years several broadband wireless technologies have been developed to meet the growing number of broadband subscribers and to provide more and better applications and services. The second generation wireless communication system has been developed to provide voice services while ensuring the mobility of users. Third generation wireless communication system supports not only the voice service but also data service. In recent years, the fourth wireless communication system has been developed to provide high-speed data service. However, currently, the fourth generation wireless communication system suffers from lack of resources to meet the growing demand for high speed data services. So fifth generation wireless communication system (also referred as next generation radio or NR) is being developed to meet the growing demand for high speed data services, support ultra-reliability and low latency applications.

The fifth generation wireless communication system supports not only lower frequency bands but also in higher frequency (e.g., mmWave) bands, e.g., 10 GHz to 100 GHz bands, so as to accomplish higher data rates. To mitigate propagation loss of the radio waves and increase the transmission distance, the beamforming, massive Multiple-Input Multiple-Output (MIMO), Full Dimensional MIMO (FD-MIMO), array antenna, an analog beam forming, large scale antenna techniques are being considered in the design of fifth generation wireless communication system. In addition, the fifth generation wireless communication system is expected to address different use cases having quite different requirements in terms of data rate, latency, reliability, mobility etc. However, it is expected that the design of the air-interface of the fifth generation wireless communication system would be flexible enough to serve the UEs having quite different capabilities depending on the use case and market segment the UE cater service to the end customer. Few example use cases the fifth generation wireless communication system wireless system is expected to address is enhanced Mobile Broadband (eMBB), massive Machine Type Communication (m-MTC), ultra-reliable low latency communication (URLLC) etc. The eMBB requirements like tens of Gbps data rate, low latency, high mobility so on and so forth address the market segment representing the conventional wireless broadband subscribers needing internet connectivity everywhere, all the time and on the go. The m-MTC requirements like very high connection density, infrequent data transmission, very long battery life, low mobility address so on and so forth address the market segment representing the Internet of Things (IoT)/Internet of Everything (IoE) envisioning connectivity of billions of devices. The URLLC requirements like very low latency, very high reliability and variable mobility so on and so forth address the market segment rep-resenting the Industrial automation application, vehicle-to-vehicle/vehicle-to-infrastructure communication foreseen as one of the enabler for autonomous cars.

In the fifth generation wireless communication system operating in higher frequency (mmWave) bands, UE and gNB communicates with each other using Beamforming. Beamforming techniques are used to mitigate the propagation path losses and to increase the propagation distance for communication at higher frequency band. Beamforming enhances the transmission and reception performance using a high-gain antenna. Beamforming can be classified into Transmission (TX) beamforming performed in a transmitting end and reception (RX) beamforming performed in a receiving end. In general, the TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of the TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. The RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming technique, a transmitter can make plurality of transmit beam patterns of different directions. Each of these transmit beam patterns can be also referred as TX beam. Wireless communication system operating at high frequency uses plurality of narrow TX beams to transmit signals in the cell as each narrow TX beam provides coverage to a part of cell. The narrower the TX beam, higher is the antenna gain and hence the larger the propagation distance of signal transmitted using beamforming. A receiver can also make plurality of RX beam patterns of different directions. Each of these receive patterns can be also referred as receive (RX) beam.

Carrier-Aggregation(CA)/Multi-connectivity in fifth generation wireless communication system: The fifth generation wireless communication system, supports standalone mode of operation as well dual connectivity (DC). In DC a multiple Rx/Tx UE may be configured to utilise resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in a radio resource control (RRC) connected (RRC_CONNECTED) is configured to utilise radio resources provided by two distinct schedulers, located in two different nodes connected via a non-ideal backhaul and providing either Evolved Universal Mobile Telecommunications System (UMTS) Terrestrial Radio Access (E-UTRA) (i.e., if the node is an ng-eNB) or NR access (i.e., if the node is a gNB). In NR for a UE in RRC_CONNECTED not configured with CA/DC there is only one serving cell comprising of the primary cell. For a UE in RRC_CONNECTED configured with CA/ DC the term ‘serving cells’ is used to denote the set of cells comprising of the Special Cell(s) and all secondary cells. In NR the term Master Cell Group (MCG) refers to a group of serving cells associated with the Master Node, comprising of the Primary Cell (PCell) and optionally one or more Secondary Cells (SCells). In NR the term Secondary Cell Group (SCG) refers to a group of serving cells associated with the Secondary Node, comprising of the primary SCG Cell (PSCell) and optionally one or more SCells. In NR PCell refers to a serving cell in MCG, operating on the primary frequency, in which the UE either performs the initial connection establishment procedure or initiates the connection re-establishment procedure. In NR for a UE configured with CA, Scell is a cell providing additional radio resources on top of Special Cell. PSCell refers to a serving cell in SCG in which the UE performs random access when performing the Reconfiguration with Sync procedure. For Dual Connectivity operation the term SpCell (i.e., Special Cell) refers to the PCell of the MCG or the PSCell of the SCG, otherwise the term Special Cell refers to the PCell.

Bandwidth Part (BWP) operation in fifth generation wireless communication system: In fifth generation wireless communication system bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g. to increase scheduling flexibility); and the subcarrier spacing can be ordered to change (e.g. to allow different services). A subset of the total cell bandwidth of a cell is referred to as a BWP. BA is achieved by configuring RRC connected UE with BWP(s) and telling the UE which of the configured BWPs is currently the active one. When BA is configured, the UE only has to monitor physical downlink control channel (PDCCH) on the one active BWP i.e. it does not have to monitor PDCCH on the entire DL frequency of the serving cell. In RRC connected state, UE is configured with one or more DL and UL BWPs, for each configured Serving Cell (i.e., PCell or SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC signaling, or by the MAC entity itself upon initiation of Random Access procedure. Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

Random access in fifth generation wireless communication system: In the 5G wireless communication system, random access (RA) is supported. Random access (RA) is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by non-synchronized UE in RRC CONNECTED state.

Contention based random access (CBRA): This is also referred as 4 step CBRA. In this type of random access, UE first transmits Random Access preamble (also referred as Msg1) and then waits for Random access response (RAR) in the RAR window. RAR is also referred as Msg2. Next generation node B (gNB) transmits the RAR on physical downlink shared channel (PDSCH). PDCCH scheduling the PDSCH carrying RAR is addressed to RA-radio network temporary identifier (RA-RNTI). RA-RNTI identifies the time-frequency resource (also referred as physical RA channel (PRACH) occasion or PRACH transmission (TX) occasion or RA channel (RACH) occasion) in which RA preamble was detected by gNB. The RA-RNTI is calculated as follows: RA-RNTI=1+s_id+14*t_id+14*80*f_id+14*80*8*ul_carrier_id, where s_id is the index of the first orthogonal frequency division multiplexing (OFDM) symbol of the PRACH occasion where UE has transmitted Msg 1, i.e. RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier. Several RARs for various Random access preambles detected by gNB can be multiplexed in the same RAR media access control (MAC) protocol data unit (PDU) by gNB. An RAR in MAC PDU corresponds to UE's RA preamble transmission if the RAR includes an RA preamble identifier (RAPID) of RA preamble transmitted by the UE. If the RAR corresponding to its RA preamble transmission is not received during the RAR window and UE has not yet transmitted the RA preamble for a configurable (configured by gNB in RACH configuration) number of times, the UE goes back to first step (i.e., select random access resource (preamble/RACH occasion)) and transmits the RA preamble. A backoff may be applied before going back to first step.

If the RAR corresponding to its RA preamble transmission is received the UE transmits message 3 (Msg3) in UL grant received in RAR. Msg3 includes message such as RRC connection request, RRC connection re-establishment request, RRC handover confirm, scheduling request, SI request etc. It may include the UE identity (i.e., cell-radio network temporary identifier (C-RNTI) or system architecture evolution (SAE)-temporary mobile subscriber identity (S-TMSI) or a random number). After transmitting the Msg3, UE starts a contention resolution timer. While the contention resolution timer is running, if UE receives a PDCCH addressed to C-RNTI included in Msg3, contention resolution is considered successful, contention resolution timer is stopped and RA procedure is completed. While the contention resolution timer is running, if UE receives contention resolution MAC control element (CE) including the UE's contention resolution identity (first X bits of common control channel (CCCH) service data unit (SDU) transmitted in Msg3), contention resolution is considered successful, contention resolution timer is stopped and RA procedure is completed. If the contention resolution timer expires and UE has not yet transmitted the RA preamble for a configurable number of times, UE goes back to first step (i.e., select random access resource (preamble/RACH occasion)) and transmits the RA preamble. A backoff may be applied before going back to first step.

Contention free random access (CFRA): This is also referred as legacy CFRA or 4 step CFRA. CFRA procedure is used for scenarios such as handover where low latency is required, timing advance establishment for Scell, etc. Evolved node B (eNB) assigns to UE dedicated Random access preamble. UE transmits the dedicated RA preamble. ENB transmits the RAR on PDSCH addressed to RA-RNTI. RAR conveys RA preamble identifier and timing alignment information. RAR may also include UL grant. RAR is transmitted in RAR window similar to contention based RA (CBRA) procedure. CFRA is considered successfully completed after receiving the RAR including RA preamble identifier (RAPID) of RA preamble transmitted by the UE. In case RA is initiated for beam failure recovery, CFRA is considered successfully completed if PDCCH addressed to C-RNTI is received in search space for beam failure recovery. If the RAR window expires and RA is not successfully completed and UE has not yet transmitted the RA preamble for a configurable (configured by gNB in RACH configuration) number of times, the UE retransmits the RA preamble.

For certain events such has handover and beam failure recovery if dedicated preamble(s) are assigned to UE, during first step of random access i.e., during random access resource selection for Msg1 transmission UE determines whether to transmit dedicated preamble or non dedicated preamble. Dedicated preambles is typically provided for a subset of SSBs/CSI RSs. If there is no SSB/CSI RS having DL reference signal received power (RSRP) above a threshold amongst the SSBs/CSI RSs for which contention free random access resources (i.e. dedicated preambles/ROs) are provided by gNB, UE select non dedicated preamble. Otherwise UE select dedicated preamble. So, during the RA procedure, one random access attempt can be CFRA while other random access attempt can be CBRA.

2 step contention based random access (2 step CBRA): In the first step, UE transmits random access preamble on PRACH and a payload (i.e., MAC PDU) on physical uplink shared channel (PUSCH). The random access preamble and payload transmission is also referred as MsgA. In the second step, after MsgA transmission, the UE monitors for a response from the network (i.e. g, NB) within a configured window. The response is also referred as MsgB. Next generation node B (gNB) transmits the MsgB on PDSCH. PDCCH scheduling the PDSCH carrying MsgB is addressed to MsgB-radio network temporary identifier (MSGB-RNTI). MSGB-RNTI identifies the time-frequency resource (also referred as physical RA channel (PRACH) occasion or PRACH TX occasion or RACH occasion) in which RA preamble was detected by gNB. The MSGB-RNTI is calculated as follows: RA-RNTI=1+s_id+14*t_id+14*80*f_id+14*80*8*ul_carrier_id+14×80×8×2, where s_id is the index of the first orthogonal frequency division multiplexing (OFDM) symbol of the PRACH occasion where UE has transmitted Msg 1, i.e. RA preamble; 0≤s_id<14; t_id is the index of the first slot of the PRACH occasion (0≤t_id<80); f_id is the index of the PRACH occasion within the slot in the frequency domain (0≤f_id<8), and ul_carrier_id is the UL carrier used for Msg1 transmission (0 for normal UL (NUL) carrier and 1 for supplementary UL (SUL) carrier.

If CCCH SDU was transmitted in MsgA payload, UE performs contention resolution using the contention resolution information in MsgB. The contention resolution is successful if the contention resolution identity received in MsgB matches first 48 bits of CCCH SDU transmitted in MsgA. If C-RNTI was transmitted in MsgA payload, the contention resolution is successful if UE receives PDCCH addressed to C-RNTI. If contention resolution is successful, random access procedure is considered successfully completed. Instead of contention resolution information corresponding to the transmitted MsgA, MsgB may include a fallback information corresponding to the random access preamble transmitted in MsgA. If the fallback information is received, UE transmits Msg3 and performs contention resolution using Msg4 as in CBRA procedure. If contention resolution is successful, random access procedure is considered successfully completed. If contention resolution fails upon fallback (i.e., upon transmitting Msg3), UE retransmits MsgA. If configured window in which UE monitor network response after transmitting MsgA expires and UE has not received MsgB including contention resolution information or fallback information as explained above, UE retransmits MsgA. If the random access procedure is not successfully completed even after transmitting the msgA configurable number of times, UE fallbacks to 4 step RACH procedure i.e. UE only transmits the PRACH preamble.

MsgA payload may include one or more of common control channel (CCCH) service data unit (SDU), dedicated control channel (DCCH) SDU, dedicated traffic channel (DTCH) SDU, buffer status report (BSR) MAC control element (CE), power headroom report (PHR) MAC CE, SSB information, C-RNTI MAC CE, or padding.

MsgA may include UE ID (e.g., random ID, S-TMSI, C-RNTI, resume ID, etc.) along with preamble in first step. The UE ID may be included in the MAC PDU of the MsgA. UE ID such as C-RNTI may be carried in MAC CE wherein MAC CE is included in MAC PDU. Other UE IDs (such random ID, S-TMSI, C-RNTI, resume ID, etc.) may be carried in CCCH SDU. The UE ID can be one of random ID, S-TMSI, C-RNTI, resume ID, IMSI, idle mode ID, inactive mode ID, etc. The UE ID can be different in different scenarios in which UE performs the RA procedure. When UE performs RA after power on (before it is attached to the network), then UE ID is the random ID. When UE perform RA in IDLE state after it is attached to network, the UE ID is S-TMSI. If UE has an assigned C-RNTI (e.g., in connected state), the UE ID is C-RNTI. In case UE is in INACTIVE state, UE ID is resume ID. In addition to UE ID, some addition ctrl information can be sent in MsgA. The control information may be included in the MAC PDU of the MsgA. The control information may include one or more of connection request indication, connection resume request indication, SI request indication, buffer status indication, beam information (e.g., one or more DL TX beam ID(s) or SSB ID(s)), beam failure recovery indication/information, data indicator, cell/BS/TRP switching indication, connection re-establishment indication, reconfiguration complete or handover complete message, etc.

2 step contention free random access (2 step CFRA): In this case gNB assigns to UE dedicated Random access preamble(s) and PUSCH resource(s) for MsgA transmission. RO(s) to be used for preamble transmission may also be indicated. In the first step, UE transmits random access preamble on PRACH and a payload on PUSCH using the contention free random access resources (i.e. dedicated preamble/PUSCH resource/RO). In the second step, after MsgA transmission, the UE monitors for a response from the network (i.e., gNB) within a configured window. The response is also referred as MsgB.

Next generation node B (gNB) transmits the MsgB on physical downlink shared channel (PDSCH). PDCCH scheduling the PDSCH carrying MsgB is addressed to MsgB-radio network temporary identifier (MSGB-RNTI). MSGB-RNTI identifies the time-frequency resource (also referred as physical RA channel (PRACH) occasion or PRACH transmission (TX) occasion or RA channel (RACH) occasion) in which RA preamble was detected by gNB. The MSGB-RNTI is calculated as follows: RA-RNTI=1+s_id+14*t_id+14*80*f_id+14*80*8*ul_carrier_id+14×80×8×2, where s_id is the index of the first orthogonal frequency division multiplexing (OFDM) symbol of the PRACH occasion where UE has transmitted Msg1, i.e. RA preamble; 0≤s_id<14 ; t_id is the index of the first slot of the PRACH occasion (0≤t_id<80); f_id is the index of the PRACH occasion within the slot in the frequency domain (0≤f_id<8), and ul_carrier_id is the UL carrier used for Msg 1 transmission (0 for normal UL (NUL) carrier and 1 for supplementary UL (SUL) carrier.

If UE receives PDCCH addressed to C-RNTI, random access procedure is considered successfully completed. If UE receives fallback information corresponding to its transmitted preamble, random access procedure is considered successfully completed.

For certain events such has handover and beam failure recovery if dedicated preamble(s) and PUSCH resource(s) are assigned to UE, during first step of random access i.e., during random access resource selection for MsgA transmission UE determines whether to transmit dedicated preamble or non dedicated preamble. Dedicated preambles is typically provided for a subset of SSBs/CSI RSs. If there is no SSB/CSI RS having DL RSRP above a threshold amongst the SSBs/CSI RSs for which contention free random access resources (i.e., dedicated preambles/ROs/PUSCH resources) are provided by gNB, UE select non dedicated preamble. Otherwise, UE select dedicated preamble. So, during the RA procedure, one random access attempt can be 2 step CFRA while other random access attempt can be 2 step CBRA.

Upon initiation of random access procedure, UE first selects the carrier (SUL or NUL). If the carrier to use for the Random Access procedure is explicitly signalled by gNB, UE select the signalled carrier for performing Random Access procedure. If the carrier to use for the Random Access procedure is not explicitly signalled by gNB; and if the Serving Cell for the Random Access procedure is configured with supplementary uplink and if the RSRP of the downlink pathloss reference is less than rsrp-ThresholdSSB-SUL: UE select the SUL carrier for performing Random Access procedure. Otherwise, UE select the NUL carrier for performing Random Access procedure. Upon selecting the UL carrier, UE determines the UL and DL BWP for random access procedure. UE then determines whether to perform 2 step or 4 step RACH for this random access procedure.
If this random access procedure is initiated by PDCCH order and if the ra-PreambleIndex explicitly provided by PDCCH is not 0b000000, UE selects 4 step RACH.
else if 2 step contention free random access resources are signaled by gNB for this random access procedure, UE selects 2 step RACH.
else if 4 step contention free random access resources are signaled by gNB for this random access procedure, UE selects 4 step RACH.
else if the UL BWP selected for this random access procedure is configured with only 2 step RACH resources, UE selects 2 step RACH.
else if the UL BWP selected for this random access procedure is configured with only 4 step RACH resources, UE selects 4 step RACH.
else if the UL BWP selected for this random access procedure is configured with both 2 step and 4 step RACH resources,
if RSRP of the downlink pathloss reference is below a configured threshold, UE selects 4 step RACH. Otherwise UE selects 2 step RACH.

In the 5^{th} generation (also referred as NR or New Radio) wireless communication system UE can be in one of the following RRC state: RRC IDLE, RRC INACTIVE and RRC CONNECTED. The RRC states can further be characterized as follows:

In RRC_IDLE state, a UE specific DRX may be configured by upper layers (i.e., non-access stratum (NAS)). The UE, monitors Short Messages transmitted with P-RNTI (paging RNTI) over downlink control information (DCI); Monitors a Paging channel for CN paging using 5G-S-TMSI; Performs neighbouring cell measurements and cell (re-)selection; Acquires system information and can send SI request (if configured).

In RRC_INACTIVE state, a UE specific DRX may be configured by upper layers or by RRC layer; In this state, UE stores the UE Inactive AS context. A RAN-based notification area is configured by RRC layer. The UE monitors Short Messages transmitted with P-RNTI over DCI; Monitors a Paging channel for CN paging using 5G-S-TMSI and RAN paging using fullI-RNTI; Performs neighbouring cell measurements and cell (re-)selection; Performs RAN-based notification area updates periodically and when moving outside the configured RAN-based notification area; Acquires system information and can send SI request (if configured).

In the RRC_CONNECTED, the UE stores the AS context. Unicast data is transmitted/received to/from UE. At lower layers, the UE may be configured with a UE specific DRX. The UE, monitors Short Messages transmitted with P-RNTI over DCI, if configured; Monitors control channels associated with the shared data channel to determine if data is scheduled for it; Provides channel quality and feedback information; Performs neighbouring cell measurements and measurement reporting; Acquires system information.

The 5G or Next Generation Radio Access Network (NG-RAN) based on NR consists of NG-RAN nodes where NG-RAN node is a gNB, providing NR user plane and control plane protocol terminations towards the UE. The gNBs are also connected by means of the NG interfaces to the 5GC, more specifically to the AMF (Access and Mobility Management Function) by means of the NG-C interface and to the UPF (User Plane Function) by means of the NG-U interface. In the 5^{th} generation (also referred as NR or New Radio) wireless communication system, the UE may use Discontinuous Reception (DRX) in RRC_IDLE and RRC_INACTIVE state in order to reduce power consumption. In the RRC_IDLE/RRC_INACTIVE state UE wake ups at regular intervals (i.e., every DRX cycle) for short periods to receive paging, to receive SI update notification and to receive emergency notifications. Paging message is transmitted using PDSCH. PDCCH is addressed to P-RNTI if there is a paging message in PDSCH. P-RNTI is common for all UEs. UE identity (i.e., S-TMSI for RRC_IDLE UE or I-RNTI for RRC_INACTIVE UE) is included in paging message to indicate paging for a specific UE. Paging message may include multiple UE identities to page multiple UEs. Paging message is broadcasted (i.e., PDCCH is masked with P-RNTI) over data channel (i.e., PDSCH). SI update and emergency notifications are included in DCI and PDCCH carrying this DCI is addressed to P-RNTI. In the RRC idle/inactive mode UE monitors one paging occasion (PO) every DRX cycle. In the RRC idle/inactive mode UE monitors PO in initial DL BWP. In RRC connected state UE monitors one or more POs to receive SI update notification and to receive emergency notifications. In RRC connected state, UE can monitor any PO in paging DRX cycle and monitors at least one PO in SI modification period. In the RRC idle/inactive mode UE monitors PO every DRX cycle in its active DL BWP. A PO is a set of ‘S’ PDCCH monitoring occasions for paging, where ‘S’ is the number of transmitted SSBs (i.e., the Synchronization Signal and PBCH block (SSB) consists of primary and secondary synchronization signals (PSS, SSS) and PBCH) in cell. UE first determines the paging frame (PF) and then determines the PO with respect to the determined PF. One PF is a radio frame (10ms).

Multicast reception in fifth generation wireless communication system: A multicast communication service is delivered to the UEs using a multicast session. A UE can receive a multicast communication service in RRC_CONNECTED state with mechanisms such as point-to-point (PTP) and/or point-to-multipoint (PTM) delivery. Hybrid automatic repeat request (HARQ) feedback/retransmission can be applied to both PTP and PTM transmission. For a multicast session, gNB provides multicast MRB (multicast radio bearer) configuration(s) to the UE via dedicated RRC signalling: If the UE which joined a multicast session is in RRC_CONNECTED state and when the multicast session is activated, the gNB sends RRCReconfiguration message with relevant multicast and broadcast service (MBS) configuration for the multicast session to the UE. The gNB may use RRCReconfiguration message to configure or reconfigure a multicast MRB, e.g., add/release/modify the MRB's radio link control (RLC) entities.

When there is (temporarily) no data to be sent to the UEs for a multicast session, the gNB may move the UE to RRC IDLE/INACTIVE state. gNBs supporting MBS use a group notification mechanism to notify the UEs in RRC IDLE/INACTIVE state when a multicast session has been activated by the CN or the gNB has multicast session data to deliver. Upon reception of the group notification, the UEs reconnect to the network i.e., it initiated connection setup/resumption and enters RRC_CONNECTED. The group notification is addressed with P-RNTI on PDCCH.

Meanwhile, to minimize connection setup/resumption by UEs in RRC_INACTIVE state, multicast reception by UEs in RRC_INACTIVE state can be considered in fifth generation wireless communication system. Network may provide multicast reception configuration for RRC_INACTIVE in RRC_Release/RRC Reconfiguration message. UE enters RRC_INACTIVE and starts multicast reception based on the configuration. In case of Multicast reception in RRC_INACTIVE, UE needs to resume the multicast MRBs (PDCP entities are re-established). The issue is whether UE continues robust header compression (ROHC) or reset it during PDCP re-establishment upon initiation of Multicast reception in RRC_INACTIVE. Note that UE may initiate multicast MBS reception in RRC_INACTIVE in a cell different from the cell where UE entered RRC_INACTIVE.

### Embodiment 1

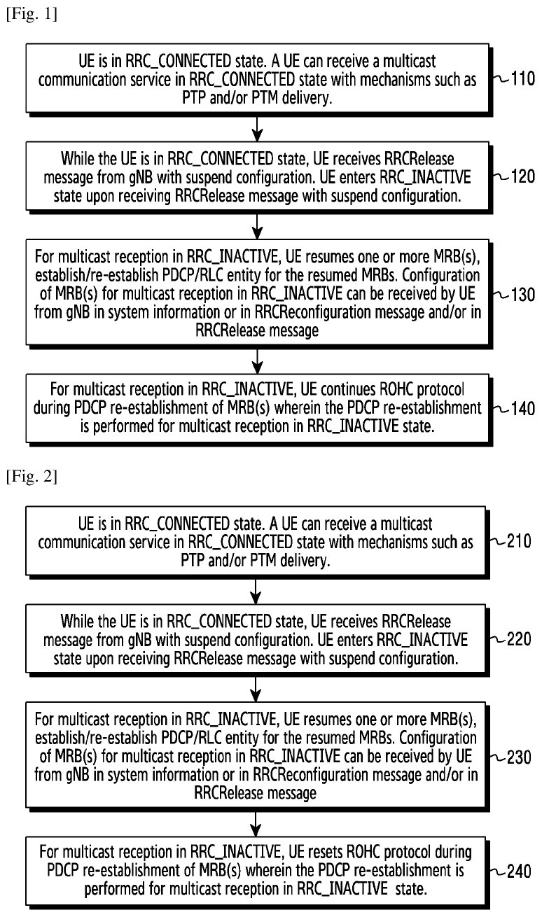

FIG. 1 illustrates an example of a header compression handling procedure in accordance with an embodiment of the disclosure.

In an embodiment of this disclosure, operation is as follows:
Step 1 (110): UE is in RRC_CONNECTED state. A UE can receive a multicast communication service in RRC_CONNECTED state with mechanisms such as PTP and/or PTM delivery. For a multicast session, gNB provides multicast MRB configuration(s) to the UE via dedicated RRC signalling (e.g., RRCReconfiguration). If the UE has joined a multicast session and when the multicast session is activated, the gNB sends RRCReconfiguration message with relevant MBS configuration for the multicast session to the UE. The gNB may use RRCReconfiguration message to configure or reconfigure a multicast MRB, e.g., add/release/modify the MRB's RLC entities.
Step 2 (120): While the UE is in RRC_CONNECTED state, UE receives RRCRelease message from gNB with suspend configuration. UE enters RRC_INACTIVE state upon receiving RRCRelease message with suspend configuration.
Step 3 (130): While in RRC_INACTIVE state, UE receives multicast reception for the multicast session which the UE has joined. UE initiate procedure to receive multicast reception in RRC_INACTIVE (e.g., resume one or more MRB(s), establish/ re-establish PDCP/RLC entity for the resumed MRBs, etc.). Configuration of MRB(s) for multicast reception in RRC_INACTIVE can be received by UE from gNB in system information or in RRCReconfiguration message and/or in RRCRelease message.
Step 4 (140): For multicast reception in RRC_INACTIVE, UE resumes one or more MRB(s) and establish/re-establish PDCP/RLC entity for the resumed MRBs. The resumption of one or more MRB(s) and establishment/re-establishment of PDCP/RLC entities for the resumed MRB(s) can also be performed when UE perform reselection from one cell to another in RRC_INACTIVE state while receiving multicast reception.
UE continues ROHC protocol (i.e., not reset) during PDCP re-establishment of MRB, if ROHC is configured for the MRB, wherein the PDCP re-establishment is performed for multicast reception in RRC_INACTIVE state.
   For ROHC it is assumed that ROHC Unidirectional (ROHC-U) mode is configured/applied for MRB(s). If ROHC bidirectional Optimistic (ROHC-O) or ROHC bidirectional Reliable (ROHC-R) mode is configured in the MRB configuration (for multicast reception in RRC_INACTIVE), UE resets and ignores ROHC configuration for ROHC-O or R mode during PDCP re-establishment wherein the PDCP re-establishment is performed for multicast reception in RRC_INACTIVE state.

UE continues ethernet header compression (EHC) protocol (i.e., not reset) during PDCP re-establishment of MRB, if EHC is configured for the MRB in the MRB configuration (for multicast reception in RRC_INACTIVE), wherein the PDCP re-establishment is performed for multicast reception in RRC_INACTIVE state.

### Embodiment 2

FIG. 2 illustrates another example of a header compression handling procedure in accordance with an embodiment of the disclosure.

In an embodiment of this disclosure, operation is as follows:
Step 1 (210): UE is in RRC_CONNECTED state. A UE can receive a multicast communication service in RRC_CONNECTED state with mechanisms such as PTP and/or PTM delivery. For a multicast session, gNB provides multicast MRB configuration(s) to the UE via dedicated RRC signalling (e.g., RRCReconfiguration). If the UE has joined a multicast session and when the multicast session is activated, the gNB sends RRCReconfiguration message with relevant MBS configuration for the multicast session to the UE. The gNB may use RRCReconfiguration message to configure or re-configure a multicast MRB, e.g., add/release/modify the MRB's RLC entities.
Step 2 (220): While the UE is in RRC_CONNECTED state, UE receives RRCRelease message from gNB with suspend configuration. UE enters RRC_INACTIVE state upon receiving RRCRelease message with suspend configuration.
Step 3 (230): While in RRC_INACTIVE state, UE receives multicast reception for the multicast session which the UE has joined. UE initiate procedure to receive multicast reception in RRC_INACTIVE (e.g., resume one or more MRB(s), establish/ re-establish PDCP/RLC entity for the resumed MRBs, etc.). Configuration of MRB(s) for multicast reception in RRC_INACTIVE can be received by UE from gNB in system information or in RRCReconfiguration message and/or in RRCRelease message.
Step 4 (240): For multicast reception in RRC_INACTIVE UE resumes one or more MRB(s) and establish/re-establish PDCP/RLC entity for the resumed MRBs. The resumption of one or more MRB(s) and establishment/re-establishment of PDCP/RLC entities for the resumed MRB(s) can also be performed when UE perform reselection from one cell to another in RRC_INACTIVE state while receiving multicast reception.
UE resets ROHC protocol during PDCP re-establishment of MRB, if ROHC is configured for the MRB in the MRB configuration (for multicast reception in RRC_INACTIVE), wherein the PDCP re-establishment is performed for multicast reception in RRC_INACTIVE state. UE reset the ROHC protocol for downlink and start with no context (NC) state in U-mode.
   For ROHC it is assumed that ROHC-U mode is configured/applied for MRB(s). If ROHC-O or ROHC-R mode is configured in the MRB configuration (for multicast reception in RRC_INACTIVE), UE reset and ignores ROHC configuration for ROHC-O or R mode during PDCP re-establishment wherein the PDCP re-establishment is performed for multicast reception in RRC_INACTIVE state.
UE resets EHC protocol during PDCP re-establishment of MRB, if EHC is configured for the MRB in the MRB configuration (for multicast reception in RRC_INACTIVE), wherein the PDCP re-establishment is performed for multicast reception in RRC_INACTIVE state.

### Embodiment 3

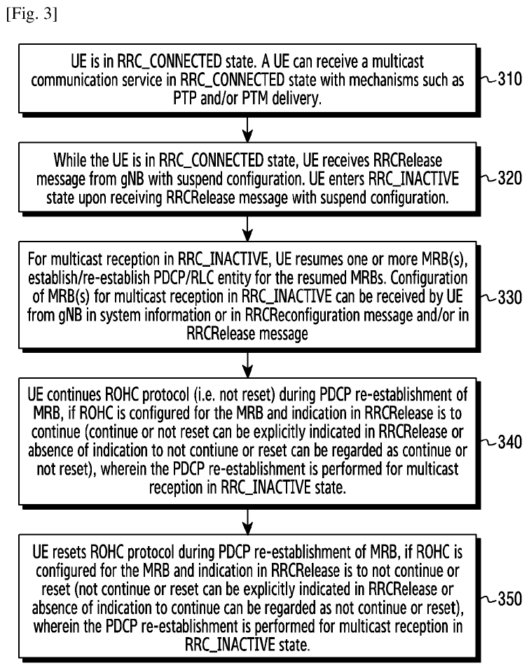

FIG. 3 illustrates another example of a header compression handling procedure in accordance with an embodiment of the disclosure.

In an embodiment of this disclosure, operation is as follows:
Step 1 (310): UE is in RRC_CONNECTED state. A UE can receive a multicast communication service in RRC_CONNECTED state with mechanisms such as PTP and/or PTM delivery. For a multicast session, gNB provides multicast MRB configuration(s) to the UE via dedicated RRC signalling (e.g., RRCReconfiguration). If the UE has joined a multicast session and when the multicast session is activated, the gNB sends RRCReconfiguration message with relevant MBS configuration for the multicast session to the UE. The gNB may use RRCReconfiguration message to configure or re-configure a multicast MRB, e.g., add/release/modify the MRB's RLC entities.
Step 2 (320): While the UE is in RRC_CONNECTED state, UE receives RRCRelease message from gNB with suspend configuration. UE enters RRC_INACTIVE state upon receiving RRCRelease message with suspend configuration.
Step 3 (330): While in RRC_INACTIVE state, UE receives multicast reception for the multicast session which the UE has joined. UE initiate procedure to receive multicast reception in RRC_INACTIVE (e.g., resume one or more MRB(s), establish/ re-establish PDCP/RLC entity for the resumed MRBs, etc.). Configuration of MRB(s) for multicast reception in RRC_INACTIVE can be received by UE from gNB in system information or in RRCReconfiguration message and/or in RRCRelease message.
Step 4 (340, 350): For multicast reception in RRC_INACTIVE UE resumes one or more MRB(s) and establish/re-establish PDCP/RLC entity for the resumed MRBs. The resumption of one or more MRB(s) and establishment/re-establishment of PDCP/RLC entities for the resumed MRB(s) can also be performed when UE perform reselection from one cell to another in RRC_INACTIVE state while receiving multicast reception.
Indication whether to reset or continue header compression protocol (ROHC, EHC) is included in RRCRelease. It is common for all MRBs for which header compression protocol (e.g., EOHC, EHC) is applicable/configured. Indication can be separate for ROHC and EHC. Indication can be common for both ROHC and EHC.
UE continues ROHC protocol (i.e., not reset) during PDCP re-establishment of MRB, if ROHC is configured for the MRB and indication in RRCRelease is to continue (continue or not reset can be explicitly indicated in RRCRelease or absence of indication to not continue or reset can be regarded as continue or not reset), wherein the PDCP re-establishment is performed for multicast reception in RRC_INACTIVE state (340).
   For ROHC it is assumed that ROHC-U mode is configured/applied for MRB(s). If ROHC-O or ROHC-R mode is configured in the MRB configuration (for multicast reception in RRC_INACTIVE), UE reset and ignores ROHC configuration for ROHC-O or R mode during PDCP re-establishment wherein the PDCP re-establishment is performed for multicast reception in RRC_INACTIVE state.
UE continues EHC protocol (i.e., not reset) during PDCP re-establishment of MRB, if EHC is configured for the MRB and indication in RRCRelease is to continue (continue or not reset can be explicitly indicated in RRCRelease or absence of indication to not continue or reset can be regarded as continue or not reset), wherein the PDCP re-establishment is performed for multicast reception in RRC_INACTIVE state.
UE resets ROHC protocol during PDCP re-establishment of MRB, if ROHC is configured for the MRB and indication in RRCRelease is to not continue or reset (not continue or reset can be explicitly indicated in RRCRelease or absence of indication to continue can be regarded as not continue or reset), wherein the PDCP re-establishment is performed for multicast reception in RRC_INACTIVE state (350). UE reset the ROHC protocol for downlink and start with no context (NC) state in U-mode.
   If ROHC-O or ROHC-R mode is configured in the MRB configuration, UE reset and ignores ROHC configuration for ROHC-O or R mode during PDCP re-establishment wherein the PDCP re-establishment is performed for multicast reception in RRC_INACTIVE state.
UE resets EHC protocol during PDCP re-establishment of MRB, if EHC is configured for the MRB and indication in RRCRelease is to not continue or reset (not continue or reset can be explicitly indicated in RRCRelease or absence of indication to continue can be regarded as not continue or reset), wherein the PDCP re-establishment is performed for multicast reception in RRC_INACTIVE state.
In an embodiment the indication to continue or reset header compression protocol (as described above) can be signalled in system information and UE performs the above operation based on this indication instead of indication in RRCRelease.

### Embodiment 4

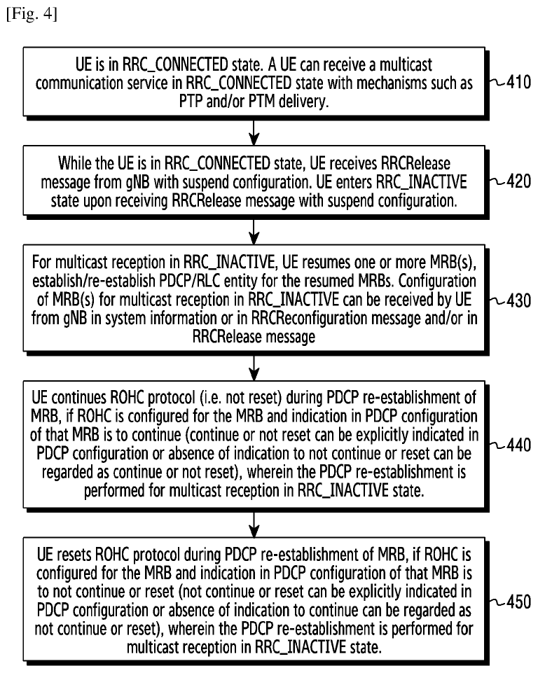

FIG. 4 illustrates another example of a header compression handling procedure in accordance with an embodiment of the disclosure.

In an embodiment of this disclosure, operation is as follows:
Step 1 (410): UE is in RRC_CONNECTED state. A UE can receive a multicast communication service in RRC_CONNECTED state with mechanisms such as PTP and/or PTM delivery. For a multicast session, gNB provides multicast MRB configuration(s) to the UE via dedicated RRC signalling (e.g., RRCReconfiguration). If the UE has joined a multicast session and when the multicast session is activated, the gNB sends RRCReconfiguration message with relevant MBS configuration for the multicast session to the UE. The gNB may use RRCReconfiguration message to configure or re-configure a multicast MRB, e.g., add/release/modify the MRB's RLC entities.
Step 2 (420): While the UE is in RRC_CONNECTED state, UE receives RRCRelease message from gNB with suspend configuration. UE enters RRC_INACTIVE state upon receiving RRCRelease message with suspend configuration.
Step 3 (430): While in RRC_INACTIVE state, UE receives multicast reception for the multicast session which the UE has joined. UE initiate procedure to receive multicast reception in RRC_INACTIVE (e.g., resume one or more MRB(s), establish/ re-establish PDCP/RLC entity for the resumed MRBs, etc.). Configuration of MRB(s) for multicast reception in RRC_INACTIVE can be received by UE from gNB in system information or in RRCReconfiguration message and/or in RRCRelease message.
Step 4 (440, 450): For multicast reception in RRC_INACTIVE UE resumes one or more MRB(s) and establish/re-establish PDCP/RLC entity for the resumed MRBs. The resumption of one or more MRB(s) and establishment/re-establishment of PDCP/RLC entities for the resumed MRB(s) can also be performed when UE perform reselection from one cell to another in RRC_INACTIVE state while receiving multicast reception.
Indication whether to reset or continue header compression protocol (ROHC, EHC) is included in PDCP configuration of MRB configuration.
UE continues ROHC protocol (i.e., not reset) during PDCP re-establishment of MRB, if ROHC is configured for the MRB and indication in PDCP configuration of that MRB is to continue (continue or not reset can be explicitly indicated in PDCP configuration or absence of indication to not continue or reset can be regarded as continue or not reset), wherein the PDCP re-establishment is performed for multicast reception in RRC_INACTIVE state (440).
   For ROHC it is assumed that ROHC-U mode is configured/applied for MRB(s). If ROHC-O or ROHC-R mode is configured in the MRB configuration (for multicast reception in RRC_INACTIVE), UE reset and ignores ROHC configuration for ROHC-O or R mode during PDCP re-establishment wherein the PDCP re-establishment is performed for multicast reception in RRC_INACTIVE state.
UE continues EHC protocol (i.e., not reset) during PDCP re-establishment of MRB, if EHC is configured for the MRB and indication in PDCP configuration of that MRB is to continue (continue or not reset can be explicitly indicated in PDCP configuration or absence of indication to not continue or reset can be regarded as continue or not reset), wherein the PDCP re-establishment is performed for multicast reception in RRC_INACTIVE state.
UE resets ROHC protocol during PDCP re-establishment of MRB, if ROHC is configured for the MRB and indication in PDCP configuration of that MRB is to not continue or reset (not continue or reset can be explicitly indicated in PDCP configuration or absence of indication to continue can be regarded as not continue or reset), wherein the PDCP re-establishment is performed for multicast reception in RRC_INACTIVE state (450). UE reset the ROHC protocol for downlink and start with NC state in U-mode.
   For ROHC it is assumed that ROHC-U mode is configured/applied for MRB(s). If ROHC-O or ROHC-R mode is configured in the MRB configuration (for multicast reception in RRC_INACTIVE), UE reset and ignores ROHC configuration for ROHC-O or R mode during PDCP re-establishment wherein the PDCP re-establishment is performed for multicast reception in RRC_INACTIVE state.
UE resets EHC protocol during PDCP re-establishment of MRB, if EHC is configured for the MRB and indication in PDCP configuration of that MRB is to not continue or reset (not continue or reset can be explicitly indicated in PDCP configuration or absence of indication to continue can be regarded as not continue or reset), wherein the PDCP re-establishment is performed for multicast reception in RRC_INACTIVE state.

### Embodiment 5

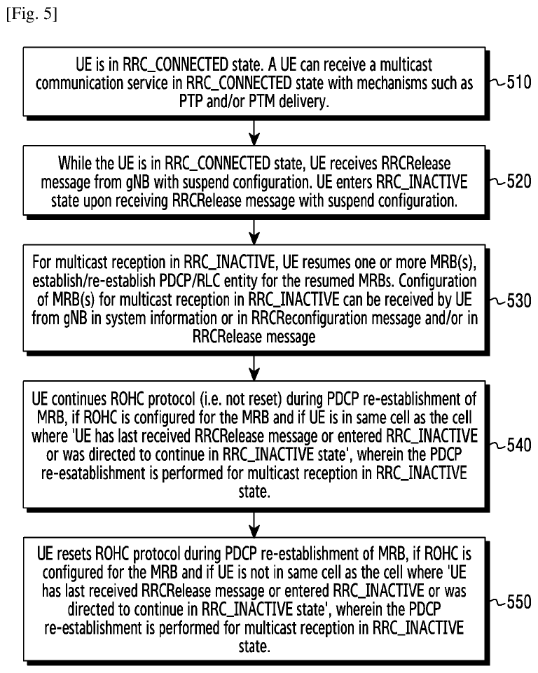

FIG. 5 illustrates another example of a header compression handling procedure in accordance with an embodiment of the disclosure.

In an embodiment of this disclosure, operation is as follows:
Step 1 (510): UE is in RRC_CONNECTED state. A UE can receive a multicast communication service in RRC_CONNECTED state with mechanisms such as PTP and/or PTM delivery. For a multicast session, gNB provides multicast MRB configuration(s) to the UE via dedicated RRC signalling (e.g., RRCReconfiguration). If the UE has joined a multicast session and when the multicast session is activated, the gNB sends RRCReconfiguration message with relevant MBS configuration for the multicast session to the UE. The gNB may use RRCReconfiguration message to configure or re-configure a multicast MRB, e.g., add/release/modify the MRB's RLC entities.
Step 2 (520): While the UE is in RRC_CONNECTED state, UE receives RRCRelease message from gNB with suspend configuration. UE enters RRC_INACTIVE state upon receiving RRCRelease message with suspend configuration.
Step 3 (530): While in RRC_INACTIVE state, UE receives multicast reception for the multicast session which the UE has joined. UE initiate procedure to receive multicast reception in RRC_INACTIVE (e.g., resume one or more MRB(s), establish/ re-establish PDCP/RLC entity for the resumed MRBs, etc.). Configuration of MRB(s) for multicast reception in RRC_INACTIVE can be received by UE from gNB in system information or in RRCReconfiguration message and/or in RRCRelease message.
Step 4 (540, 550): For multicast reception in RRC_INACTIVE UE resumes one or more MRB(s) and establish/re-establish PDCP/RLC entity for the resumed MRBs. The resumption of one or more MRB(s) and establishment/re-establishment of PDCP/RLC entities for the resumed MRB(s) can also be performed when UE perform reselection from one cell to another in RRC_INACTIVE state while receiving multicast reception.
UE continues ROHC protocol (i.e., not reset) during PDCP re-establishment of MRB, if ROHC is configured for the MRB and if UE is in same cell as the cell where ‘UE has last received RRCRelease message or entered RRC_INACTIVE or was directed to continue in RRC_INACTIVE state’, wherein the PDCP re-establishment is performed for multicast reception in RRC_INACTIVE state (540).
   For ROHC it is assumed that ROHC-U mode is configured/applied for MRB(s). If ROHC-O or ROHC-R mode is configured in the MRB configuration (for multicast reception in RRC_INACTIVE), UE reset and ignores ROHC configuration for ROHC-O or R mode during PDCP re-establishment wherein the PDCP re-establishment is performed for multicast reception in RRC_INACTIVE state.
UE continues EHC protocol (i.e., not reset) during PDCP re-establishment of MRB, if EHC is configured for the MRB in the MRB configuration (for multicast reception in RRC_INACTIVE) and if UE is in same cell as the cell where ‘UE has last received RRCRelease message or entered RRC_INACTIVE or was directed to continue in RRC_INACTIVE state’, wherein the PDCP re-establishment is performed for multicast reception in RRC_INACTIVE state.
UE resets ROHC protocol during PDCP re-establishment of MRB, if ROHC is configured for the MRB in the MRB configuration (for multicast reception in RRC_INACTIVE) and if UE is not in same cell as the cell where ‘UE has last received RRCRelease message or entered RRC_INACTIVE or was directed to continue in RRC_INACTIVE state’, wherein the PDCP re-establishment is performed for multicast reception in RRC_INACTIVE state (550). UE reset the ROHC protocol for downlink and start with NC state in U-mode.
   For ROHC it is assumed that ROHC-U mode is configured/applied for MRB(s). If ROHC-O or ROHC-R mode is configured in the MRB configuration (for multicast reception in RRC_INACTIVE), UE reset and ignores ROHC configuration for ROHC-O or R mode during PDCP re-establishment wherein the PDCP re-establishment is performed for multicast reception in RRC_INACTIVE state.

UE resets EHC protocol during PDCP re-establishment of MRB, if EHC is configured for the MRB and if UE is not in same cell as the cell where ‘UE has last received RRCRelease message or entered RRC_INACTIVE or was directed to continue in RRC_INACTIVE state’, wherein the PDCP re-establishment is performed for multicast reception in RRC_INACTIVE state.

### Embodiment 6

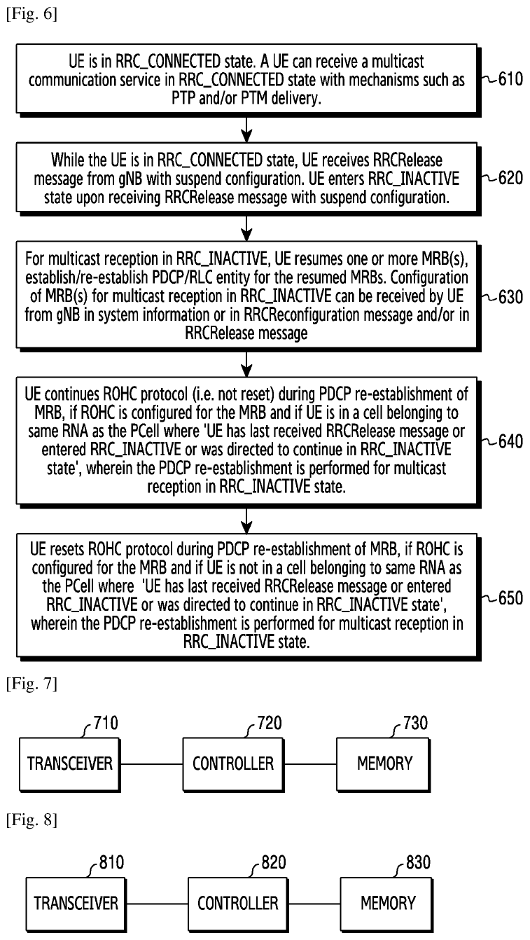

FIG. 6 illustrates another example of a header compression handling procedure in accordance with an embodiment of the disclosure.

In an embodiment of this disclosure, operation is as follows:
Step 1 (610): UE is in RRC_CONNECTED state. A UE can receive a multicast communication service in RRC_CONNECTED state with mechanisms such as PTP and/or PTM delivery. For a multicast session, gNB provides multicast MRB configuration(s) to the UE via dedicated RRC signalling (e.g., RRCReconfiguration). If the UE has joined a multicast session and when the multicast session is activated, the gNB sends RRCReconfiguration message with relevant MBS configuration for the multicast session to the UE. The gNB may use RRCReconfiguration message to configure or re-configure a multicast MRB, e.g., add/release/modify the MRB's RLC entities.
Step 2 (620): While the UE is in RRC_CONNECTED state, UE receives RRCRelease message from gNB with suspend configuration. UE enters RRC_INACTIVE state upon receiving RRCRelease message with suspend configuration.
Step 3 (630): While in RRC_INACTIVE state, UE receives multicast reception for the multicast session which the UE has joined. UE initiate procedure to receive multicast reception in RRC_INACTIVE (e.g., resume one or more MRB(s), establish/ re-establish PDCP/RLC entity for the resumed MRBs, etc.). Configuration of MRB(s) for multicast reception in RRC_INACTIVE can be received by UE from gNB in system information or in RRCReconfiguration message and/or in RRCRelease message.
Step 4 (640): For multicast reception in RRC_INACTIVE UE resumes one or more MRB(s) and establish/re-establish PDCP/RLC entity for the resumed MRBs. The resumption of one or more MRB(s) and establishment/re-establishment of PDCP/RLC entities for the resumed MRB(s) can also be performed when UE perform reselection from one cell to another in RRC_INACTIVE state while receiving multicast reception.
UE continues ROHC protocol (i.e., not reset) during PDCP re-establishment of MRB, if ROHC is configured for the MRB in the MRB configuration (for multicast reception in RRC_INACTIVE) and if UE is in a cell belonging to same radio access network notification area (RNA) as the PCell where ‘UE has last received RRCRelease message or entered RRC_INACTIVE or was directed to continue in RRC_INACTIVE state’, wherein the PDCP re-establishment is performed for multicast reception in RRC_INACTIVE state (640).
   For ROHC it is assumed that ROHC-U mode is configured/applied for MRB(s). If ROHC-O or ROHC-R mode is configured in the MRB configuration (for multicast reception in RRC_INACTIVE), UE reset and ignores ROHC configuration for ROHC-O or R mode during PDCP re-establishment wherein the PDCP re-establishment is performed for multicast reception in RRC_INACTIVE state.
UE continues EHC protocol (i.e., not reset) during PDCP re-establishment of MRB, if EHC is configured for the MRB and if UE is in a cell belonging to same RNA as the PCell where ‘UE has last received RRCRelease message or entered RRC_INACTIVE or was directed to continue in RRC_INACTIVE state’, wherein the PDCP re-establishment is performed for multicast reception in RRC_INACTIVE state.
UE resets ROHC protocol during PDCP re-establishment of MRB, if ROHC is configured for the MRB and if UE is not in a cell belonging to same RNA as the PCell where ‘UE has last received RRCRelease message or entered RRC_INACTIVE or was directed to continue in RRC_INACTIVE state’, wherein the PDCP re-establishment is performed for multicast reception in RRC_INACTIVE state (650). UE reset the ROHC protocol for downlink and start with NC state in U-mode.
   For ROHC it is assumed that ROHC-U mode is configured/applied for MRB(s). If ROHC-O or ROHC-R mode is configured in the MRB configuration (for multicast reception in RRC_INACTIVE), UE reset and ignores ROHC configuration for ROHC-O or R mode during PDCP re-establishment wherein the PDCP re-establishment is performed for multicast reception in RRC_INACTIVE state.
UE resets EHC protocol during PDCP re-establishment of MRB, if EHC is configured for the MRB and if UE is not in a cell belonging to same RNA as the PCell where ‘UE has last received RRCRelease message or entered RRC_INACTIVE or was directed to continue in RRC_INACTIVE state’, wherein the PDCP re-establishment is performed for multicast reception in RRC_INACTIVE state.

### Embodiment 7

In an embodiment of this disclosure, operation is as follows:
Step 1: UE is in RRC_CONNECTED state. A UE can receive a multicast communication service in RRC_CONNECTED state with mechanisms such as PTP and/or PTM delivery. For a multicast session, gNB provides multicast MRB configuration(s) to the UE via dedicated RRC signalling (e.g., RRCReconfiguration). If the UE has joined a multicast session and when the multicast session is activated, the gNB sends RRCReconfiguration message with relevant MBS configuration for the multicast session to the UE. The gNB may use RRCReconfiguration message to configure or re-configure a multicast MRB, e.g., add/release/modify the MRB's RLC entities.
Step 2: While the UE is in RRC_CONNECTED state, UE receives RRCRelease message from gNB with suspend configuration. UE enters RRC_INACTIVE state upon receiving RRCRelease message with suspend configuration.
Step 3: While in RRC_INACTIVE state, UE receives multicast reception for the multicast session which the UE has joined. UE initiate procedure to receive multicast reception in RRC_INACTIVE (e.g., resume one or more MRB(s), establish/ re-establish PDCP/RLC entity for the resumed MRBs, etc.). Configuration of MRB(s) for multicast reception in RRC_INACTIVE can be received by UE from gNB in system information or in RRCReconfiguration message and/or in RRCRelease message.
Step 4: For multicast reception in RRC_INACTIVE UE resumes one or more MRB(s) and establish/re-establish PDCP/RLC entity for the resumed MRBs. The resumption of one or more MRB(s) and establishment/re-establishment of PDCP/RLC entities for the resumed MRB(s) can also be performed when UE perform reselection from one cell to another in RRC_INACTIVE state while receiving multicast reception.

If UE receive indication in RRCRelease/RRC Reconfiguration or system information to continue header compression protocol (e.g., ROHC, EHC) if UE is in a cell belonging to same RNA as the Pcell where ‘UE has last received RRCRelease message or entered RRC_INACTIVE or was directed to continue in RRC_INACTIVE state’ (note that indication can be separate for ROHC and EHC or it can be common for ROHC and EHC):
UE continues ROHC protocol (i.e., not reset) during PDCP re-establishment of MRB, if ROHC is configured for the MRB and if UE is in a cell belonging to same RNA as the Pcell where ‘UE has last received RRCRelease message or entered RRC_INACTIVE or was directed to continue in RRC_INACTIVE state’, wherein the PDCP re-establishment is performed for multicast reception in RRC_INACTIVE state.
   For ROHC it is assumed that ROHC-U mode is configured/applied for MRB(s). If ROHC-O or ROHC-R mode is configured in the MRB configuration (for multicast reception in RRC_INACTIVE), UE reset and ignores ROHC configuration for ROHC-O or R mode during PDCP re-establishment wherein the PDCP re-establishment is performed for multicast reception in RRC_INACTIVE state.
UE continues EHC protocol (i.e., not reset) during PDCP re-establishment of MRB, if EHC is configured for the MRB and if UE is in a cell belonging to same RNA as the Pcell where ‘UE has last received RRCRelease message or entered RRC_INACTIVE or was directed to continue in RRC_INACTIVE state’, wherein the PDCP re-establishment is performed for multicast reception in RRC_INACTIVE state.
UE resets ROHC protocol during PDCP re-establishment of MRB, if ROHC is configured for the MRB and if UE is not in a cell belonging to same RNA as the Pcell where ‘UE has last received RRCRelease message or entered RRC_INACTIVE or was directed to continue in RRC_INACTIVE state’, wherein the PDCP re-establishment is performed for multicast reception in RRC_INACTIVE state. UE reset the ROHC protocol for downlink and start with NC state in U-mode.
   For ROHC it is assumed that ROHC-U mode is configured/applied for MRB(s). If ROHC-O or ROHC-R mode is configured in the MRB configuration (for multicast reception in RRC_INACTIVE), UE reset and ignores ROHC configuration for ROHC-O or R mode during PDCP re-establishment wherein the PDCP re-establishment is performed for multicast reception in RRC_INACTIVE state.
UE resets EHC protocol during PDCP re-establishment of MRB, if EHC is configured for the MRB and if UE is not in a cell belonging to same RNA as the Pcell where ‘UE has last received RRCRelease message or entered RRC_INACTIVE or was directed to continue in RRC_INACTIVE state’, wherein the PDCP re-establishment is performed for multicast reception in RRC_INACTIVE state.

If UE receive indication in RRCRelease/RRC Reconfiguration or system information to continue header compression protocol (ROHC, EHC) if UE is in a cell as the Pcell where ‘UE has last received RRCRelease message or entered RRC_INACTIVE or was directed to continue in RRC_INACTIVE state’ (note that indication can be separate for ROHC and EHC or it can be common for ROHC and EHC):
UE continues ROHC protocol (i.e., not reset) during PDCP re-establishment of MRB, if ROHC is configured for the MRB and if UE is in same cell as the cell where ‘UE has last received RRCRelease message or entered RRC_INACTIVE or was directed to continue in RRC_INACTIVE state’, wherein the PDCP re-establishment is performed for multicast reception in RRC_INACTIVE state.
   For ROHC it is assumed that ROHC-U mode is configured/applied for MRB(s). If ROHC-O or ROHC-R mode is configured in the MRB configuration, UE reset and ignores ROHC configuration for ROHC-O or R mode during PDCP re-establishment wherein the PDCP re-establishment is performed for multicast reception in RRC_INACTIVE state.
UE continues EHC protocol (i.e., not reset) during PDCP re-establishment of MRB, if EHC is configured for the MRB and if UE is in same cell as the cell where ‘UE has last received RRCRelease message or entered RRC_INACTIVE or was directed to continue in RRC_INACTIVE state’, wherein the PDCP re-establishment is performed for multicast reception in RRC_INACTIVE state.
UE resets ROHC protocol during PDCP re-establishment of MRB, if ROHC is configured for the MRB in the MRB configuration (for multicast reception in RRC_INACTIVE) and if UE is not in same cell as the cell where ‘UE has last received RRCRelease message or entered RRC_INACTIVE or was directed to continue in RRC_INACTIVE state’, wherein the PDCP re-establishment is performed for multicast reception in RRC_INACTIVE state. UE reset the ROHC protocol for downlink and start with NC state in U-mode.
   For ROHC it is assumed that ROHC-U mode is configured/applied for MRB(s). If ROHC-O or ROHC-R mode is configured in the MRB configuration (for multicast reception in RRC_INACTIVE), UE reset and ignores ROHC configuration for ROHC-O or R mode during PDCP re-establishment wherein the PDCP re-establishment is performed for multicast reception in RRC_INACTIVE state.
UE resets EHC protocol during PDCP re-establishment of MRB, if EHC is configured for the MRB and if UE is not in same cell as the cell where ‘UE has last received RRCRelease message or entered RRC_INACTIVE or was directed to continue in RRC_INACTIVE state’, wherein the PDCP re-establishment is performed for multicast reception in RRC_INACTIVE state.

### Embodiment 8

In an embodiment of this disclosure, operation is as follows:
Step 1: UE is in RRC_CONNECTED state. A UE can receive a multicast communication service in RRC_CONNECTED state with mechanisms such as PTP and/or PTM delivery. For a multicast session, gNB provides multicast MRB configuration(s) to the UE via dedicated RRC signalling (e.g., RRCReconfiguration). If the UE has joined a multicast session and when the multicast session is activated, the gNB sends RRCReconfiguration message with relevant MBS configuration for the multicast session to the UE. The gNB may use RRCReconfiguration message to configure or re-configure a multicast MRB, e.g., add/release/modify the MRB's RLC entities.
Step 2: While the UE is in RRC_CONNECTED state, UE receives RRCRelease message from gNB with suspend configuration. UE enters RRC_INACTIVE state upon receiving RRCRelease message with suspend configuration.
Step 3: While in RRC_INACTIVE state, UE receives multicast reception for the multicast session which the UE has joined. UE initiate procedure to receive multicast reception in RRC_INACTIVE (e.g., resume one or more MRB(s), establish/ re-establish PDCP/RLC entity for the resumed MRBs, etc.). Configuration of MRB(s) for multicast reception in RRC_INACTIVE can be received by UE from gNB in system information or in RRCReconfiguration message and/or in RRCRelease message.
Step 4: For multicast reception in RRC_INACTIVE UE resumes one or more MRB(s) and establish/re-establish PDCP/RLC entity for the resumed MRBs. The resumption of one or more MRB(s) and establishment/re-establishment of PDCP/RLC entities for the resumed MRB(s) can also be performed when UE perform reselection from one cell to another in RRC_INACTIVE state while receiving multicast reception.
UE continues ROHC protocol (i.e., not reset) during PDCP re-establishment of MRB, if ROHC is configured for the MRB and if the cell where UE is currently camped is in list of cells included in last received RRCRelease message (or RRC re-configuration message or system information), wherein the PDCP re-establishment is performed for multicast reception in RRC_INACTIVE state.
   For ROHC it is assumed that ROHC-U mode is configured/applied for MRB(s). If ROHC-O or ROHC-R mode is configured in the MRB configuration (for multicast reception in RRC_INACTIVE), UE reset and ignores ROHC configuration for ROHC-O or R mode during PDCP re-establishment wherein the PDCP re-establishment is performed for multicast reception in RRC_INACTIVE state.
UE continues EHC protocol (i.e., not reset) during PDCP re-establishment of MRB, if EHC is configured for the MRB and if the cell where UE is currently camped is in list of cells included in last received RRCRelease message (or RRC reconfiguration message or system information), wherein the PDCP re-establishment is performed for multicast reception in RRC_INACTIVE state.
UE resets ROHC protocol during PDCP re-establishment of MRB, if ROHC is configured for the MRB and if the cell where UE is currently camped is not in list of cells included in last received RRCRelease message (or RRC reconfiguration message or system information), wherein the PDCP re-establishment is performed for multicast reception in RRC_INACTIVE state. UE reset the ROHC protocol for downlink and start with NC state in U-mode.
   For ROHC it is assumed that ROHC-U mode is configured/applied for MRB(s). If ROHC-O or ROHC-R mode is configured in the MRB configuration (for multicast reception in RRC_INACTIVE), UE reset and ignores ROHC configuration for ROHC-O or R mode during PDCP re-establishment wherein the PDCP re-establishment is performed for multicast reception in RRC_INACTIVE state.
UE resets EHC protocol during PDCP re-establishment of MRB, if EHC is configured for the MRB and if the cell where UE is currently camped is not in list of cells included in last received RRCRelease message (or RRC reconfiguration message or system information), wherein the PDCP re-establishment is performed for multicast reception in RRC_INACTIVE state.

### Embodiment 9

In an embodiment of this disclosure, operation is as follows:
Step 1: UE is in RRC_CONNECTED state. A UE can receive a multicast communication service in RRC_CONNECTED state with mechanisms such as PTP and/or PTM delivery. For a multicast session, gNB provides multicast MRB configuration(s) to the UE via dedicated RRC signalling (e.g., RRCReconfiguration). If the UE has joined a multicast session and when the multicast session is activated, the gNB sends RRCReconfiguration message with relevant MBS configuration for the multicast session to the UE. The gNB may use RRCReconfiguration message to configure or re-configure a multicast MRB, e.g., add/release/modify the MRB's RLC entities.
Step 2: While the UE is in RRC_CONNECTED state, UE receives RRCRelease message from gNB with suspend configuration. UE enters RRC_INACTIVE state upon receiving RRCRelease message with suspend configuration.
Step 3: While in RRC_INACTIVE state, UE receives multicast reception for the multicast session which the UE has joined. UE initiate procedure to receive multicast reception in RRC_INACTIVE (e.g., resume one or more MRB(s), establish/ re-establish PDCP/RLC entity for the resumed MRBs, etc.). Configuration of MRB(s) for multicast reception in RRC_INACTIVE can be received by UE from gNB in system information or in RRCReconfiguration message and/or in RRCRelease message.
Step 4: For multicast reception in RRC_INACTIVE UE resumes one or more MRB(s) and establish/re-establish PDCP/RLC entity for the resumed MRBs. The resumption of one or more MRB(s) and establishment/re-establishment of PDCP/RLC entities for the resumed MRB(s) can also be performed when UE perform reselection from one cell to another in RRC_INACTIVE state while receiving multicast reception.
UE continues ROHC protocol (i.e., not reset) during PDCP re-establishment of MRB, if ROHC is configured for the MRB and if the cell where UE is currently camped belongs to the AREA (AREA ID) same as the AREA (AREA ID) of the PCell where UE last received RRCRelease or entered RRC_INACTIVE state, wherein the PDCP re-establishment is performed for multicast reception in RRC_INACTIVE state. AREA ID of cell can be transmitted/received by gNB/UE in system information. AREA IDs of cells can be transmitted/received by gNB/UE in RRC message or NAS message. In an embodiment AREA ID can be tracking area ID or RAN notification area ID or system information area ID or a new ID.
   For ROHC it is assumed that ROHC-U mode is configured/applied for MRB(s). If ROHC-O or ROHC-R mode is configured in the MRB configuration (for multicast reception in RRC_INACTIVE), UE reset and ignores ROHC configuration for ROHC-O or R mode during PDCP re-establishment wherein the PDCP re-establishment is performed for multicast reception in RRC_INACTIVE state.
UE continues EHC protocol (i.e., not reset) during PDCP re-establishment of MRB, if EHC is configured for the MRB and if the cell where UE is currently camped belongs to the AREA (AREA ID) same as the AREA (AREA ID) of the PCell where UE last received RRCRelease or entered RRC_INACTIVE state, wherein the PDCP re-establishment is performed for multicast reception in RRC_INACTIVE state.
UE resets ROHC protocol during PDCP re-establishment of MRB, if ROHC is configured for the MRB and if the cell where UE is currently camped does not belong to the AREA (AREA ID) same as the AREA (AREA ID) of the PCell where UE last received RRCRelease or entered RRC_INACTIVE state, wherein the PDCP re-establishment is performed for multicast reception in RRC_INACTIVE state. UE reset the ROHC protocol for downlink and start with NC state in U-mode.
   For ROHC it is assumed that ROHC-U mode is configured/applied for MRB(s). If ROHC-O or ROHC-R mode is configured in the MRB configuration (for multicast reception in RRC_INACTIVE), UE reset and ignores ROHC configuration for ROHC-O or R mode during PDCP re-establishment wherein the PDCP re-establishment is performed for multicast reception in RRC_INACTIVE state.
UE resets EHC protocol during PDCP re-establishment of MRB, if EHC is configured for the MRB and if the cell where UE is currently camped does not belong to the AREA (AREA ID) same as the AREA (AREA ID) of the PCell where UE last received RRCRelease or entered RRC_INACTIVE state, wherein the PDCP re-establishment is performed for multicast reception in RRC_INACTIVE state.

In an embodiment of this disclosure gNB may indicate in RRC signaling (e.g., RRCRelease) message a method (amongst the embodiments 1 to 9 or amongst the subset of embodiments 1 to 9) is applied by UE upon cell reselection while receiving multicast reception in RRC_INACTIVE.

### Embodiment 10

In an embodiment of this disclosure,
If MRB configuration applied in RRC_CONNECTED is indicated to be used for multicast reception in RRC_INACTIVE,
   If the MRB configuration indicates ROHC-O or ROHC-R mode,
      Option 1: UE assumes that ROHC is not applied in RRC_INACTIVE for this MRB.
      Option 2: UE assumes that ROHC-U is applied in RRC_INACTIVE for this MRB.
      Option 3: network indicates whether UE applies behaviour as per option 1 or option 2.
   If the MRB configuration indicates EHC,
      Option 1: UE assumes that header compression is not applied in RRC_INACTIVE for this MRB.
      Option 2: UE assumes that ROHC-U is applied in RRC_INACTIVE for this MRB.
      Option 3: network indicates whether UE applies behaviour as per option 1 or option 2.
   In an embodiment, headerCompression field can be separately included in PDCP config for RRC_INACTIVE and RRC_CONNECTED. ROHC-O or ROHC-R mode are not configured for RRC_INACTIVE. headerCompression field for RRC_INACTIVE in PDCP configuration of MRB indicates header compression configuration for multicast reception in RRC_INACTIVE for this MRB. headerCompression field for RRC_CONNECTED in PDCP configuration of MRB indicates header compression configuration for multicast reception in RRC_CONNECTED for this MRB.

In an embodiment of this disclosure, network may signal a signal threshold (e.g., RSRP threshold or reference signal received quality (RSRQ) threshold) for multicast reception in RRC_INACTIVE state. If DL signal quality in camped cell is greater than this threshold (or if the RSRP or RSRQ of the downlink pathloss reference is higher than threshold), UE can receive multicast reception in RRC_INACTIVE state and it initiates procedure to receive multicast reception in RRC_INACTIVE state. Otherwise, UE does not receive multicast reception in RRC_INACTIVE state, it may initiate connection resume procedure to enter RRC_CONNECTED state and receive multicast reception in RRC_CONNECTED. Threshold can be signalled in system information, RRC signalling message or RRC Release message or RRC Reconfiguration message.

In an embodiment multiple cells can be scheduled by single DCI transmitted by gNB. One of the issue is how to indicate BWP switching/BWP for multiple cells. For example, gNB may send PDCCH addressed to C-RNTI wherein the DCI includes multiple UL grants, each UL grant is for a different serving cell of the UE. UE uses the UL grant for UL transmission towards the corresponding serving cell. In another example, gNB may send PDCCH addressed to C-RNTI wherein the DCI includes scheduling information for multiple DL TBs, each DL TB is transmitted by a serving cell of the UE. UE uses the scheduling information to receive the DL TB from corresponding serving cell.
Option 1: A bitmap is included in DCI to indicate BWP switching or not. The size of bitmap is variable. The size of bitmap is equal to number of cells scheduled in DCI. For mapping between cells scheduled and bit in bitmap, scheduled cells can be mapped in sequence from least significant bit (LSB) to most significant bit (MSB) or MSB to LSB in the bitmap. Alternately, DCI may include a list of BWP IDs. For mapping between cells scheduled and BWP IDs, scheduled cells by DCI can be mapped in sequence starting from first BWP ID in list. BWP ID indicate the BWP of scheduled cell for which the DCI schedules DL TB or UL grant.
Option 2: A bitmap is included in DCI to indicate BWP switching or not. The size of bitmap is fixed to number of cells that can be scheduled as per RRC configuration. For mapping between cells scheduled and bit in bitmap, scheduled cells can be mapped in sequence from LSB to MSB or MSB to LSB in the bitmap. DCI may include a list of BWP IDs. For mapping between cells scheduled and BWP IDs, scheduled cells by DCI can be mapped in sequence starting from first BWP ID in list. BWP ID indicate the BWP of scheduled cell for which the DCI schedules DL TB or UL grant.
Option 3: RRC configures list of cells that can be scheduled. DCI incudes [cell index, BWP ID] or [cell index, BWP switching indicator, BWP ID in case of switching] for each cell scheduled in the DCI. BWP ID indicate the BWP of scheduled cell for which the DCI schedules DL TB or UL grant.
Option 4: RRC configures list of cells that can be scheduled. DCI incudes [Scheduling indicator, BWP ID (if scheduling indicator is set to 1)] for each cell that can be scheduled as configured by RRC. The order of cells in DCI is same as order of cells in RRC.
   Alternately, DCI includes [Scheduling indicator, BWP switching indicator (if scheduling indicator is set to 1), BWP ID (if BWP switching indicator is set to 1)] is added for each cell that can be scheduled as configured by RRC. The order of cells in DCI is same as order of cells in RRC.

Based on this information UE identifies the UL BWP of each scheduled cell and transmits using the UL grant of each scheduled cell over the identified UL BWP of that scheduled cell. Note that if current active UL BWP of scheduled cell is not the same as the identified UL BWP of that scheduled cell, UE switches active UL BWP of the scheduled cell to identified UL BWP of that scheduled cell. Based on this information UE identifies the DL BWP of each scheduled cell and received DL TB of each scheduled cell over the identified DL BWP of that scheduled cell. Note that if current active DL BWP of scheduled cell is not the same as the identified DL BWP of that scheduled cell, UE switches active DL BWP of the scheduled cell to identified DL BWP of that scheduled cell.
UE capability: UE indicates in RRC message or UE capability information message, Max number of cells that can be scheduled in UL, Max number of cells that can be scheduled in DL. This information can be per UE or per frequency range (FR) (e.g., FR1, FR2)

In an embodiment of the disclosure for UL TX Switching, NW indicates 2 bands out of the configured bands (3 or 4 bands via RRC) via DCI or MAC-CE, and dynamic Tx carrier switching between indicated bands is same as Rel-17. The MAC CE format may include:
2 ‘band index’ field in MAC CE. Each band index field indicates one of the bands configured by RRC.

Or, the MAC CE format may include:
4 bit bitmap in MAC CE, each bit corresponds to one configured band. The bands configured by RRC are sequentially mapped to each bit.

This new MAC CE is not sent by gNB if configured bands by RRC is 2. Otherwise, MAC CE is sent. In an embodiment logical channel identifier (LCID) is included in subheader of this MAC CE. In another embodiment extended LCID (eLCID) is included in subheader of this MAC CE.

Serving Cells of a MAC entity may be configured by RRC in two DRX groups with separate DRX parameters. When RRC does not configure a secondary DRX group, there is only one DRX group and all Serving Cells belong to that one DRX group. When two DRX groups are configured, each Serving Cell is uniquely assigned to either of the two groups. The DRX parameters that are separately configured for each DRX group are: drx-onDurationTimer, drx-InactivityTimer. The DRX parameters that are common to the DRX groups are: drx-SlotOffset, drx-RetransmissionTimerDL, drx-RetransmissionTimerUL, drx-LongCycleStartOffset, drx-ShortCycle (optional), drx-ShortCycleTimer (optional), drx-HARQ-RTT-TimerDL, drx-HARQ-RTT-TimerUL, downlinkHARQ-FeedbackDisabled (optional) and uplinkHARQ-Mode (optional).

When DRX is configured in RRC_CONNECTED state, if UE received a PDCCH and if the PDCCH indicates a new transmission (DL, UL or SL) on a Serving Cell of a DRX group during the active time of this DRX group: UE start or restart drx-Inactivity Timer for this DRX group in the first symbol after the end of the PDCCH reception.

In an embodiment of this disclosure the value of drx-InactivityTimer can be indicated by the DCI of PDCCH for new transmission. When DRX is configured in RRC_CONNECTED state, if UE received a PDCCH and if the PDCCH indicates a new transmission (DL, UL or SL) on a Serving Cell of a DRX group during the active time of this DRX group and the PDCCH indicates value of drx-Inactivity Timer, UE start or restart drx-InactivityTimer for this DRX group in the first symbol after the end of the PDCCH reception, wherein the value of drx-Inactivity Timer is as indicated by the DCI. If DCI does not indicate the value of drx-Inactivity Timer, UE start or restart drx-Inactivity Timer for this DRX group in the first symbol after the end of the PDCCH reception wherein the value of drx-Inactivity Timer is as indicated by the RRC for this DRX group. In an alternate embodiment, If DCI does not indicate the value of drx-InactivityTimer, UE does not restart drx-Inactivity Timer for this DRX group. In an embodiment, RRC may configure multiple values of drx-InactivityTimer for a DRX group and value indicated by DCI is one of these values.

In an embodiment, When DRX is configured in RRC_CONNECTED state, if UE received a PDCCH and if the PDCCH indicates a new transmission (DL, UL or SL) on a Serving Cell of a DRX group during the active time of this DRX group: UE start drx-Inactivity Timer for this DRX group in the first symbol after the end of the PDCCH reception, if drx-InactivityTimer is not running. If drx-Inactivity Timer is running, UE does not restart.

In an embodiment, When DRX is configured in RRC_CONNECTED state, if UE received a PDCCH and if the PDCCH indicates a new transmission (DL, UL or SL) on a Serving Cell of a DRX group during the active time of this DRX group: UE does not start drx-InactivityTimer for this DRX group in the first symbol after the end of the PDCCH reception, if drx-InactivityTimer is running and remaining time of drx-InactivityTimer is greater than threshold. Otherwise, UE start or restart drx-Inactivity Timer for this DRX group in the first symbol after the end of the PDCCH reception.

FIG. 7 is a block diagram of a terminal according to an embodiment of the disclosure.

Referring to FIG. 7, a terminal includes a transceiver 710, a controller 720 and a memory 730. The controller 720 may refer to a circuitry, an application-specific integrated circuit (ASIC), or at least one processor. The transceiver 710, the controller 720 and the memory 730 are configured to perform the operations of the UE illustrated in the figures, e.g., FIGS. 1 to 6, or described above. Although the transceiver 710, the controller 720 and the memory 730 are shown as separate entities, they may be realized as a single entity like a single chip. Or, the transceiver 710, the controller 720 and the memory 730 may be electrically connected to or coupled with each other.

The transceiver 710 may transmit and receive signals to and from other network entities, e.g., a base station. The controller 720 may control the UE to perform functions according to one of the embodiments described above.

In an embodiment, the operations of the terminal may be implemented using the memory 730 storing corresponding program codes. Specifically, the terminal may be equipped with the memory 730 to store program codes implementing desired operations. To perform the desired operations, the controller 720 may read and execute the program codes stored in the memory 730 by using a processor or a central processing unit (CPU).

FIG. 8 is a block diagram of a base station according to an embodiment of the disclosure.

Referring to FIG. 8, a base station includes a transceiver 810, a controller 820 and a memory 830. The transceiver 810, the controller 820 and the memory 830 are configured to perform the operations of the network (e.g., gNB) illustrated in the figures, e.g., FIGS. 1 to 6, or described above. Although the transceiver 810, the controller 820 and the memory 830 are shown as separate entities, they may be realized as a single entity like a single chip. The transceiver 810, the controller 820 and the memory 830 may be electrically connected to or coupled with each other.

The transceiver 810 may transmit and receive signals to and from other network entities, e.g., a terminal. The controller 820 may control the base station to perform functions according to one of the embodiments described above. The controller 820 may refer to a circuitry, an ASIC, or at least one processor. In an embodiment, the operations of the base station may be implemented using the memory 830 storing corresponding program codes. Specifically, the base station may be equipped with the memory 830 to store program codes implementing desired operations. To perform the desired operations, the controller 820 may read and execute the program codes stored in the memory 830 by using a processor or a CPU.

While the disclosure has been shown and described with reference to various embodiments thereof, it will be understood by those skilled in the art that various changes in form and details may be made therein without departing from the spirit and scope of the disclosure as defined by the appended claims and their equivalents.

As described above, embodiments disclosed in the specification and drawings are merely used to present specific examples to easily explain the contents of the disclosure and to help understanding, but are not intended to limit the scope of the disclosure. Accordingly, the scope of the disclosure should be analyzed to include all changes or modifications derived based on the technical concept of the disclosure in addition to the embodiments disclosed herein.

1-15. (canceled)

16. A method performed by a terminal in a wireless communication system, the method comprising:
receiving, from a base station, a radio resource control (RRC) release message including a suspend configuration, wherein the suspend configuration comprises information configuring a multicast and broadcast service (MBS) multicast reception in an RRC inactive state and a threshold for an RRC connection resume;
identifying that a reference signal received power (RSRP) or a reference signal received quality (RSRQ) is below the threshold; and
initiating a procedure for the RRC connection resume.

17. The method of claim 16, wherein the threshold comprises at least one of an RSRP threshold or an RSRQ threshold.

18. The method of claim 16, further comprising:
receiving an MBS multicast session in the RRC inactive state based on the information.

19. The method of claim 16, wherein the RSRP or the RSRQ is measured in a serving cell on which the terminal is camped.

20. The method of claim 16, further comprising:
receiving an MBS multicast session in an RRC connected state based on the procedure for the RRC connection resume.

21. The method of claim 16, further comprising:
performing a packet data convergence protocol (PDCP) re-establishment of a multicast radio bearer (MRB) for the MBS multicast reception in the RRC inactive state.

22. The method of claim 21,
wherein a robust header compression (ROHC) protocol is continued or reset during the PDCP re-establishment of the MRB.

23. A terminal in a wireless communication system, the terminal comprising:
a transceiver; and
a controller coupled with the transceiver and configured to:
receive, from a base station, a radio resource control (RRC) release message including a suspend configuration, wherein the suspend configuration comprises information configuring a multicast and broadcast service (MBS) multicast reception in an RRC inactive state and a threshold for an RRC connection resume,
identify that a reference signal received power (RSRP) or a reference signal received quality (RSRQ) is below the threshold, and
initiate a procedure for the RRC connection resume.

24. The terminal of claim 23, wherein the threshold comprises at least one of an RSRP threshold or an RSRQ threshold.

25. The terminal of claim 23, wherein the controller is further configured to:
receive an MBS multicast session in the RRC inactive state based on the information.

26. The terminal of claim 23, wherein the RSRP or the RSRQ is measured in a serving cell on which the terminal is camped.

27. The terminal of claim 23, wherein the controller is further configured to:
receive an MBS multicast session in an RRC connected state based on the procedure for the RRC connection resume.

28. The terminal of claim 23, wherein the controller is further configured to:
perform a packet data convergence protocol (PDCP) re-establishment of a multicast radio bearer (MRB) for the MBS multicast reception in the RRC inactive state.

29. The terminal of claim 28, wherein a robust header compression (ROHC) protocol is continued or reset during the PDCP re-establishment of the MRB.
